(19) United States
(12) Patent Application Publication
(10) Pub. No.: US 2022/0410936 A1
(43) Pub. Date: Dec. 29, 2022

(54) SYSTEM FOR MANAGING USER BASED GEOFENCE

(71) Applicant: FORD GLOBAL TECHNOLOGIES, LLC, Dearborn, MI (US)

(72) Inventor: Venkata Maruthe Ravikumara Sharma CHENGALVALA, Troy, MI (US)

(73) Assignee: FORD GLOBAL TECHNOLOGIES, LLC, Dearborn, MI (US)

(21) Appl. No.: 17/362,387

(22) Filed: Jun. 29, 2021

(51) Int. Cl. B60W 60/00; G05B 19/042; G01C 21/34

(52) U.S. Cl. CPC B60W 60/0025; G05B 19/042; G01C 21/3407; G05B 2219/2637; B60W 2556/50

(57) ABSTRACT

A vehicle includes a transceiver configured to communicate with a server; and a controller programmed to responsive to detecting a first trip pattern of the vehicle, create a first geofence associated with the first trip pattern, wherein the first geofence includes a geographic character and a temporal character, send the first geofence to the server, and responsive to receiving, from the server, a first message indicative of the first geofence being in common with a second geofence associated with an entity, establish a connection with the entity via the transceiver.

### TECHNICAL FIELD

The present disclosure generally relates to a geofence system. More specifically, the present disclosure relates to a system for managing vehicle user-based geofences for multiple users.

### BACKGROUND

Vehicle geofences have been increasingly popular in the automobile industry. Many entities use geofences to manage vehicles. For instance, a car rental company may apply a geofence to a rental car such that the rental car may only operate within the predefined area. Responsive to detecting the rental car is beyond the geofence, a message may be sent to the rental company. The geofence may be also associated with a vehicle user (e.g. driving between home and work). Multiple vehicle users may share some common geofences.

### SUMMARY

In one or more exemplary embodiments of the present disclosure, a vehicle includes a transceiver configured to communicate with a server; and a controller programmed to responsive to detecting a first trip pattern of the vehicle, create a first geofence associated with the first trip pattern, wherein the first geofence includes a geographic character and a temporal character, send the first geofence to the server, and responsive to receiving, from the server, a first message indicative of the first geofence being in common with a second geofence associated with an entity, establish a connection with the entity via the transceiver.

In one or more exemplary embodiments of the present disclosure, a mobile device includes a human-machine interface; a transceiver configured to communicate with a server; and a processor programmed to: responsive to detecting a first trip pattern of the mobile device, create a first geofence associated with the first trip pattern, wherein the first geofence includes a geographic character and a temporal character, send the first geofence to the server, responsive to receiving, from the server, a first message indicative of the first geofence being in common with a second geofence associated with an entity, establish a connection with the entity via the transceiver.

In one or more exemplary embodiments of the present disclosure, a server includes an interface, programmed to communicate with a plurality of entities including at least one vehicle and at least one mobile device; a processor, programmed to: responsive to receiving a plurality of geofences from the entities, analyze the geofences, wherein each geofence include a geographic character, a temporal character, and a type character, responsive to determining a first geofence from a first entity and a second geofence from the second entity overlap in the geographic character and the temporal character, identify a commonality between the first geofence and the second geofence, send, to the first entity and the second entity, a message indicative of the commonality.

### BRIEF DESCRIPTION OF THE DRAWINGS

For a better understanding of the invention and to show how it may be performed, embodiments thereof will now be described, by way of non-limiting example only, with reference to the accompanying drawings, in which:

FIG. 1 illustrates an example block topology of a vehicle system of one embodiment of the present disclosure;

FIG. 2 illustrates an example geofence grouping system of one embodiment of the present disclosure; and

FIG. 3 illustrates an example data flow diagram for a process of one embodiment of the present disclosure.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The present disclosure generally provides for a plurality of circuits or other electrical devices. All references to the circuits and other electrical devices, and the functionality provided by each, are not intended to be limited to encompassing only what is illustrated and described herein. While particular labels may be assigned to the various circuits or other electrical devices, such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read only memory (ROM), electrically programmable read only memory (EPROM), electrically erasable programmable read only memory (EEPROM), or other suitable variants thereof) and software which co-act with one another to perform operation(s) disclosed herein. In addition, any one or more of the electric devices may be configured to execute a computer-program that is embodied in a non-transitory computer readable medium that is programed to perform any number of the functions as disclosed.

The present disclosure, among other things, proposes a system for managing geofences associated with one or more vehicle users.

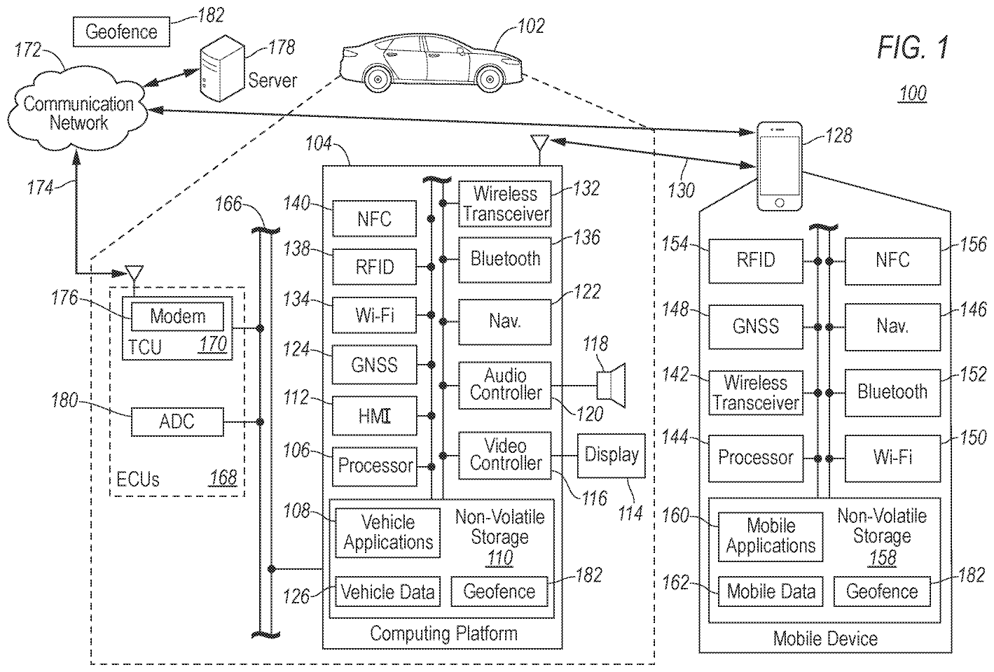

Referring to FIG. 1, an example block topology of a vehicle system 100 of one embodiment of the present disclosure is illustrated. A vehicle 102 may include various types of automobile, crossover utility vehicle (CUV), sport utility vehicle (SUV), truck, recreational vehicle (RV), boat, plane, or other mobile machine for transporting people or goods. In many cases, the vehicle 102 may be powered by an internal combustion engine. As another possibility, the vehicle 102 may be a battery electric vehicle (BEV), a hybrid electric vehicle (HEV) powered by both an internal combustion engine and one or move electric motors, such as a series hybrid electric vehicle (SHEV), a plug-in hybrid electric vehicle (PHEV), or a parallel/series hybrid vehicle (PSHEV), a boat, a plane or other mobile machine for transporting people or goods. As an example, the vehicle system 100 may include the SYNC system manufactured by The Ford Motor Company of Dearborn, Mich. It should be noted that the illustrated vehicle system 100 is merely an example, and more, fewer, and/or differently located elements may be used.

As illustrated in FIG. 1, a computing platform 104 may include one or more processors 106 configured to perform instructions, commands, and other routines in support of the processes described herein. For instance, the computing platform 104 may be configured to execute instructions of vehicle applications 108 to provide features such as navigation, remote controls, and wireless communications. Such instructions and other data may be maintained in a non-volatile manner using a variety of types of computer-readable storage medium 110. The computer-readable medium 110 (also referred to as a processor-readable medium or storage) includes any non-transitory medium (e.g., tangible medium) that participates in providing instructions or other data that may be read by the processor 106 of the computing platform 104. Computer-executable instructions may be compiled or interpreted from computer programs created using a variety of programming languages and/or technologies, including, without limitation, and either alone or in combination, Java, C, C++, C#, Objective C, Fortran, Pascal, Java Script, Python, Perl, and structured query language (SQL).

The computing platform 104 may be provided with various features allowing the vehicle occupants/users to interface with the computing platform 104. For example, the computing platform 104 may receive input from human-machine interface (HMI) controls 112 configured to provide for occupant interaction with the vehicle 102. As an example, the computing platform 104 may interface with one or more buttons, switches, knobs, or other HMI controls configured to invoke functions on the computing platform 104 (e.g., steering wheel audio buttons, a push-to-talk button, instrument panel controls, etc.).

The computing platform 104 may also drive or otherwise communicate with one or more displays 114 configured to provide visual output to vehicle occupants by way of a video controller 116. In some cases, the display 114 may be a touch screen further configured to receive user touch input via the video controller 116, while in other cases the display 114 may be a display only, without touch input capabilities. The computing platform 104 may also drive or otherwise communicate with one or more speakers 118 configured to provide audio output and input to vehicle occupants by way of an audio controller 120.

The computing platform 104 may also be provided with navigation and route planning features through a navigation controller 122 configured to calculate navigation routes responsive to user input via e.g., the HMI controls 112, and output planned routes and instructions via the speaker 118 and the display 114. Location data that is needed for navigation may be collected from a global navigation satellite system (GNSS) controller 124 configured to communicate with multiple satellites and calculate the location of the vehicle 102. The GNSS controller 124 may be configured to support various current and/or future global or regional location systems such as global positioning system (GPS), Galileo, Beidou, Global Navigation Satellite System (GLONASS) and the like. Map data used for route planning may be stored in the storage 110 as a part of the vehicle data 126. Navigation software may be stored in the storage 110 as one the vehicle applications 108.

The computing platform 104 may be configured to wirelessly communicate with a mobile device 128 of the vehicle users/occupants via a wireless connection 130. The mobile device 128 may be any of various types of portable computing devices, such as cellular phones, tablet computers, wearable devices, smart watches, smart fobs, laptop computers, portable music players, or other device capable of communication with the computing platform 104. A wireless transceiver 132 may be in communication with a Wi-Fi controller 134, a Bluetooth controller 136, a radio-frequency identification (RFID) controller 138, a near-field communication (NFC) controller 140, and other controllers such as a Zigbee transceiver, an IrDA transceiver, a ultra-wide band (UWB) controller (not shown), and configured to communicate with a compatible wireless transceiver 142 of the mobile device 128.

The mobile device 128 may be provided with a processor 144 configured to perform instructions, commands, and other routines in support of the processes such as navigation, telephone, wireless communication, and multi-media processing. For instance, the mobile device 128 may be provided with location and navigation functions via a navigation controller 146 and a GNSS controller 148. The mobile device 128 may be provided with a wireless transceiver 142 in communication with a Wi-Fi controller 150, a Bluetooth controller 152, a RFID controller 154, an NFC controller 156, and other controllers (not shown), configured to communicate with the wireless transceiver 132 of the computing platform 104. The mobile device 128 may be further provided with a non-volatile storage 158 to store various mobile application 160 and mobile data 162.

The computing platform 104 may be further configured to communicate with various components of the vehicle 102 via one or more in-vehicle network 166. The in-vehicle network 166 may include, but is not limited to, one or more of a controller area network (CAN), an Ethernet network, and a media-oriented system transport (MOST), as some examples. Furthermore, the in-vehicle network 166, or portions of the in-vehicle network 166, may be a wireless network accomplished via Bluetooth low-energy (BLE), Wi-Fi, UWB, or the like.

The computing platform 104 may be configured to communicate with various ECUs 168 of the vehicle 102 configured to perform various operations. For instance, the computing platform 104 may be configured to communicate with a telematics control unit (TCU) 170 configured to control telecommunication between vehicle 102 and a communication network 172 through a wireless connection 174 using a modem 176. The wireless connection 174 may be in the form of various communication network e.g., a cellular network. Through the communication network 172, the vehicle may access one or more servers 178 to access various content for various purposes. It is noted that the terms communication network and server are used as general terms in the present disclosure and may include any computing network involving carriers, router, computers, controllers, circuitry or the like configured to store data and perform data processing functions and facilitate communication between various entities. The ECUs 168 may further include an autonomous driving controller (ADC) 180 configured to control an autonomous driving feature of the vehicle 102. Driving instructions may be received remotely from the server 178. The ADC 180 may be configured to perform the autonomous driving features using the driving instructions combined with navigation instructions from the navigation controller 122.

As an example, the ADC 180 may operate the vehicle 102 within one or more geofences 182 automatically generated by the computing platform 104 or manually set up by a vehicle user via the HMI controls 112. The geofence data 182 may be stored in the storage 110. The geofence may be associated with the vehicle 102 and/or the vehicle user. Responsive to repeatedly detecting a trip pattern associated with one or more conditions (e.g., a time, a day or the like), the computing platform 104 may automatically generate a geofence associated with the condition to record the trip pattern. Alternatively, the computing platform 104 may output the trip pattern and ask the user's permission to record the geofence. Additionally or alternatively, one or more of the geofences 182 may be generated via the mobile device 128 in addition to or in lieu of the computing platform 104. The geofence data 182 may be uploaded to the cloud server 178 for further processing (to be discussed in detail below). Additionally or alternatively, the computing platform 104 and the mobile device may collectively detect the trip patterns and generate the geofences 182 associated thereof.

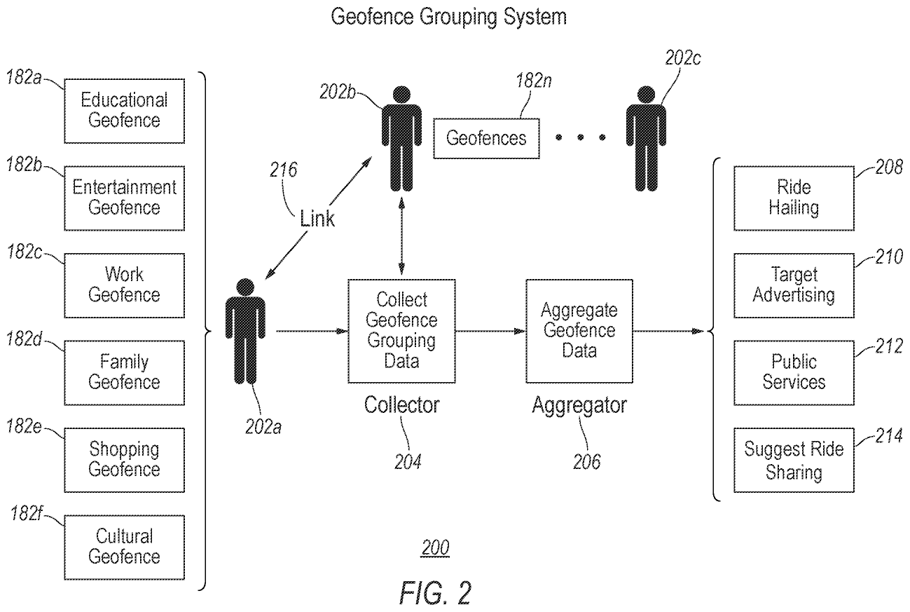

Referring to FIG. 2, an example geofence grouping system 200 of one embodiment of the present disclosure is illustrated. With continuing reference to FIG. 1, the geofence grouping system may be implemented via one of more servers 178. A vehicle user 202a may be associated with one or more geofences 182. In the present example, the vehicle user 202a may be associated with an educational geofence 182a corresponding to one or more trip patterns that the user 202a drops off and pick up a family member (e.g., a child) at an educational institute (e.g., a school). The user 202a may be further associated with an entertainment geofence 182b corresponding to one or more trip patterns that the user 202a visits for entertainment purposes (e.g., a cinema). The user 202a may be further associated with a work geofence 182c corresponding to one or more trip patterns that the user 202a travels for work. The user 202a may be further associated with a family/friend geofence 182d corresponding to trip patterns that the user 202a visits family or friends. The user 202a may be further associated with a shopping geofence 182e corresponding to one or more trip patterns for shopping. The user 202a may be further associated with a cultural religious geofence 182f corresponding to one or more trip patterns for the cultural and religious practice of the user 202a. It is noted that the geofences 182 describe herein are merely for illustrative purpose and the present invention is not limited thereto.

Each geofence 182 may be characterized by one or more geographic characters and one or more temporal characters associated with each other. The geographic characters may include one or more addresses and a zip codes associated with the corresponding trip pattern. Alternatively, the geographic characters may be defined using one or more coordinates (e.g., latitude, longitude) when the addresses or zip codes are unavailable. The temporal characters may include a day and time associated with the corresponding trip pattern. For instance, the work geofence 182 may include a first geographic character (e.g., an office building) associated with a first temporal character (e.g., Monday to Thursday, 9:00 AM-5:00 PM), a second geographic character (e.g., a construction site) associated with a second temporal character (e.g., 10:00 AM-4:00 PM).

A collector 204 of the geofence grouping system 200 may collect the geofence data 182 associated with one or more users 202 via the communication network 172. As discussed above, the collector 204 may collect the geofence data 182 from one or more vehicles 102 and/or mobile devices 128 associated with each user 202. The geofence grouping system 200 may process and aggregate the geofence data 182 collected via an aggregator 206 to abstract commonalities of the geofences 182. The geofence data 182 may be anonymized by the collector 204 before being processed by the aggregator 206. The commonalities of the geofences 182 of various users 202 may be sent to various entities for various purposes.

As a few non-limiting examples, a third party entity may plan and facilitate ride hailing services using the geographic and temporal commonalities between geofences of different users. For instance, responsive to detecting a number of users 202 shares common geographic and temporal geofences of the same type (e.g., cultural/religious geofence—Sunday LOAM to a church), the system 200 may suggest a ride hailing service 208 using the geographic and temporal conditions such that the users 202 may share a ride. The ride hailing service 208 may be based on a subscription system requiring a user to pay to access the geofence data.

The system may further facilitate target advertising 210 using the commonalities. For instance, responsive to detecting a commonality in the shopping geofence 182e across multiple users, advertisement targeting the geographic and temporal characters of the shopping geofence 182e may be generated and sent to those users. The advertisement may be individually sent to each user sharing the common geofence. Additionally or alternatively, the advertisement may be presented via a display device (e.g. a billboard) located at the commonality of the geofence.

The system 200 may further facilitate adjusting public services 212 using the geofence commonalities. An entity (e.g., a city) may adjust public services resources based on the geographic and temporal character of one or more geofences 182 aggregated. The public services may include public transportation, cellular coverage, emergency services such as police, fire, and ambulance. In addition, the public services 212 multi-modal transportations. For instance, a user may travel from point A to point B by an automobile, and then from point B to the destination point C by a train/subway. Commonality in multi-modal transport may help cities to offer services.

The system 200 may further provide a ride sharing suggestion 214 between two or more users 202 responsive to detect a commonality of the geofences between the two users 202. Responsive to receiving the suggestion from the server 178, the users 202 may establish a link (e.g., a vehicle-to-vehicle (V2V) link) to communicate and schedule the ride sharing.

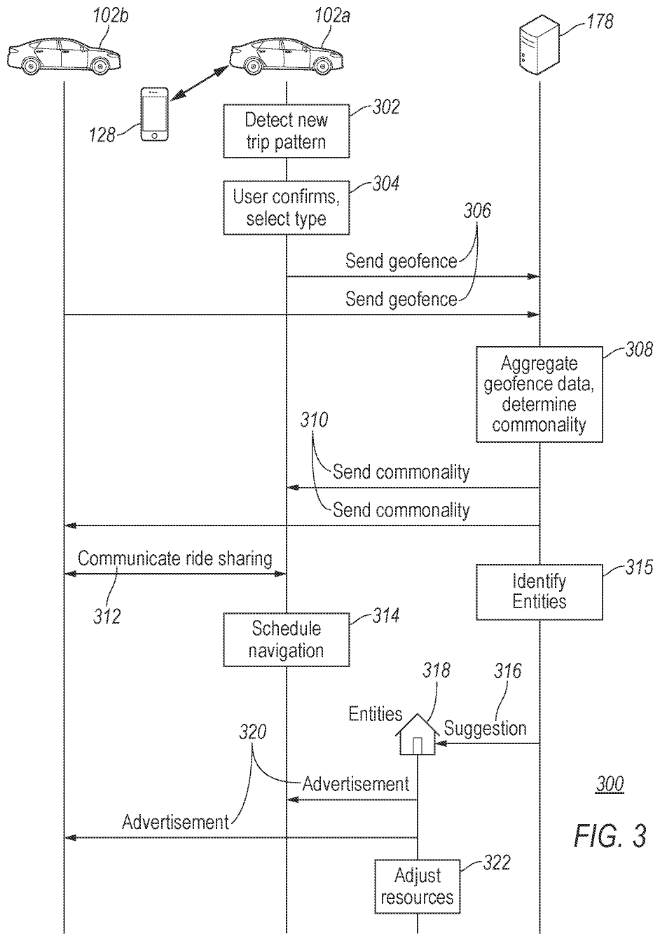

Referring to FIG. 3, an example data flow diagram for a process of one embodiment of the present disclosure is illustrated. With continuing reference to FIGS. 1 and 2, the server 178 may be configured to collect and aggregate geofence data 182 from plurality of vehicles 102 subscribed to the geofence grouping system 200. In the present example, a first vehicle 102a and second vehicle 102b are subscribed to the system 200. It is noted that although only two vehicles are illustrated in FIG. 3, the present disclosure is not limited thereto, and more vehicles or entities may be subscribed to the system 200 and in communication with the server 178. It is further noted that the term “vehicle” in the present embodiment is used as a general term and may include the vehicle itself as well as various entities associated with the vehicle. For instance, the first vehicle 102a may refer to a digital entity (e.g., the mobile device 128) associated with the first vehicle 102a.

Responsive to detecting a repeated trip pattern at operation 302, the computing platform 104 of the first vehicle 102a asks for a user confirmation to record the trip pattern as a new or existing geofence via the HMI controls 112. In case of a new geofence, the first vehicle 102a may further ask the user to select a type for the new geofence.

At operation 304, responsive to receiving a user confirmation and a selection of the geofence type, the computing platform 104 record the geofence 182 into the storage 110. As discussed above, the geofence detection and recordation may be performed via the computing platform 104 alone or in combination of the mobile device 128. As an example, the new trip pattern may be detected via the mobile device 128 independent from the vehicle 102a. In other words, the user 202 carrying the mobile device 128 may perform the trip pattern without the involvement of the first vehicle 102a. This may be important for the present user-centric geofencing system to allow the recordation of the geofences without the involvement of a specific vehicle. Alternatively, the vehicle 102a and the mobile device 128 may collectively detect the trip pattern (e.g., vehicle 102a detects a section of the trip, the mobile device 128 detects another section of the trip). The vehicle 102a may generate the geofence 182 by combining a plurality of sections into a complete trip pattern. The mobile device 128 may send the new trip pattern to the computing platform 104 for further processing described in operations 302 and 304. The second vehicle 102b may generate the geofence in a similar manner and therefore the process will not be repeated here.

At operation 306, the vehicles 102a and 102b sends the geofence data 182 to the server 178 for further processing. Responsive to receiving the geofence data 182 from the vehicles, the server 178 aggregates and abstract the geofence data 182 to determine one or more commonalities among the geofences 182. In the present example, responsive to determining a commonality between the geofences from the first vehicle 102a and the second vehicle 102b, the server 178 sends a message to each of the vehicles 102a and 102b to inform the vehicles about the commonality. The message may include an identification of the common geofences and a suggestion for a ride sharing. The message may further include an identity of the vehicles 102a and 102b and/or the users associated with the common geofence. Alternatively, the message may be anonymized to protect the privacy of the vehicle users and only allow the identification if both users allow to share their identity.

Responsive to a confirmation from both vehicle users expressing an interest for the ride sharing service, a connection 216 may be established between the two vehicles 102 as well as the mobile devices 128 associated with each respective vehicle 102. The connection 216 may be a direct connection such as a V2V or vehicle-to-everything (V2X) connection. Alternatively, the connection 216 may be a remote connection through the communication network 172. Responsive to reaching an agreement for the ride sharing, at operation 314, the first vehicle 102a may schedule a navigation to facilitate the ride sharing. Additionally, the ADC 180 of the first vehicle 102a may operate the vehicle to perform the ride sharing in an autonomous manner.

At operation 315, the server 178 may further identify one or more third party entities to share the geofence analysis result with. The server 178 may use an artificial intelligence (AI) algorithm to identify those entities. Sharing of the analysis result may be based on subscription or in certain cases may be push notifications. As an example, if a set of people travel to volunteer at a Red Cross event, the service suggestion may be sent to the city to suggest offer for free as a courtesy or at a minimal price. The server 178 may further identify the third party entities using the type of the geofence. For instance, if the commonality is related to cultural religious geofence 182f, notifications may be tailored to the sellers of religious music and books. If the commonality is related to a sports Geofence (not shown), notifications will be sent to the vendors of sports gadgets, apparels and book publishers. At operation 316, the server 178 may further share the geofence analysis result with one or more third party entity 318. As discussed above with reference to FIG. 2, the third party entity may include a business entity that may utilize the geofence commonalities for advertising purposes. In addition, the server 178 may further suggest a theme corresponding to the geofence commonalities. For instance, The server 178 may suggest playing devotional music when the commonality is visiting a church to offer prayers.

At operation 320, the third party entity 318 generates targeted advertisements using the geofence commonality and sends the advertisements to the vehicles 102. The third party entity 318 may further include a government authorities such as a city government that may use the geofence commonality to adjust public resources at operation 322. For instance, the entity 318 may adjust the public transportation and/or public services to provide more coverage to areas and times corresponding to the geofence data 182.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle comprising:
a transceiver configured to communicate with a server; and
a controller programmed to
responsive to detecting a first trip pattern of the vehicle, create a first geofence associated with the first trip pattern, wherein the first geofence includes a geographic character and a temporal character,
send the first geofence to the server, and
responsive to receiving, from the server, a first message indicative of the first geofence being in common with a second geofence associated with an entity, establish a connection with the entity via the transceiver.

2. The vehicle of claim 1, wherein the controller is further programmed to:
communicate a ride sharing arrangement with the entity; and
responsive to receiving a confirmation from the entity, schedule a ride sharing navigation.

3. The vehicle of claim 2, further comprising:
an autonomous driving controller programmed to operate the vehicle using the ride sharing navigation.

4. The vehicle of claim 1, wherein the first geofence and the second geofence overlap in the geographic character and the temporal character.

5. The vehicle of claim 1, wherein the first geofence further includes a type character, and the first geofence and the second geofence both share the type character.

6. The vehicle of claim 1, further comprising a human-machine interface (HMI), wherein the controller is further programmed to:
receive an advertisement associated with the first geofence, present the advertisement to a user via the HMI.

7. The vehicle of claim 1, wherein the transceiver is further programmed to communicate with a mobile device; and the controller is further programmed to:
responsive to detecting a first section of a second trip pattern, and to receipt, from the mobile device, of a second section of the second trip pattern, combine the first section and the second section into a complete trip pattern, and
generate a third geofence associated with the complete trip pattern.

8. The vehicle of claim 7, wherein the controller is further programmed to:
responsive to receiving a fourth geofence from the mobile device and a second message indicative of the fourth geofence being in common with the second geofence associated with the entity, establish the connection with the entity via the transceiver.

9. A mobile device, comprising:
a human-machine interface;
a transceiver configured to communicate with a server; and
a processor programmed to:
responsive to detecting a first trip pattern of the mobile device, create a first geofence associated with the first trip pattern, wherein the first geofence includes a geographic character and a temporal character,
send the first geofence to the server,
responsive to receiving, from the server, a first message indicative of the first geofence being in common with a second geofence associated with an entity, establish a connection with the entity via the transceiver.

10. The mobile device of claim 9, wherein the transceiver is further programmed to communicate with a vehicle; and the processor is further programmed to:
responsive to detecting a first section of a second trip pattern, and receiving, from the vehicle, a second section of the second trip pattern, combine the first section and the second section into a complete trip pattern,
generate a third geofence associated with the complete trip pattern, and
send the third geofence to the server.

11. The mobile device of claim 9, the transceiver is further programmed to communicate with a vehicle, and the processor is further programmed to:
communicate a ride sharing arrangement with the entity;
responsive to receiving a confirmation from the entity, schedule a ride sharing navigation; and
send the ride sharing navigation to the vehicle.

12. The mobile device of claim 9, wherein the first geofence and the second geofence overlap in the geographic character and the temporal character.

13. The mobile device of claim 9, wherein the first geofence further include a type character, and the first geofence and the second geofence both share the type character.

14. A server, comprising:
an interface, programmed to communicate with a plurality of entities including at least one vehicle and at least one mobile device;
a processor, programmed to:
responsive to receiving a plurality of geofences from the entities, analyze the geofences, wherein each geofence include a geographic character, a temporal character, and a type character,
responsive to determining a first geofence from a first entity and a second geofence from the second entity overlap in the geographic character and the temporal character, identify a commonality between the first geofence and the second geofence,
send, to the first entity and the second entity, a message indicative of the commonality.

15. The server of claim 14, wherein the message includes a suggestion for ride sharing.

16. The server of claim 14, wherein the processor is further programmed to:
generate a suggestion to adjust a public resource using the commonality.

17. The server of claim 14, wherein the processor is further programmed to:
generate a suggestion to advertise using the commonality.

18. The server of claim 14, wherein the processor is further programmed to:
identify a type of the commonality;
identify a third party using the type of the commonality; and
send a notification including the commonality to the third party.

19. The server of claim 18, wherein the notification further includes a suggestion for a theme of the commonality.
